(19) United States
(12) Patent Application Publication
(10) Pub. No.: US 2010/0174463 A1
(43) Pub. Date: Jul. 8, 2010

(54) VEHICLE BRAKING/DRIVING FORCE CONTROL APPARATUS

(75) Inventors: Yoshio Uragami, Shizuoka-ken (JP); Yoshinori Maeda, Aichi-ken (JP); Michitaka Tsuchida, Shizuoka-ken (JP); Kensuke Yoshizue, Shizuoka-ken (JP); Kazuya Okumura, Shizuoka-ken (JP); Satoshi Ando, Shizuoka-ken (JP); Koji Sugiyama, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi (JP)

(21) Appl. No.: 11/916,073

(22) PCT Filed: May 29, 2006
(86) PCT No.: PCT/JP2006/311145

§ 371 Date: Nov. 30, 2007

(30) Foreign Application Priority Data
Jun. 1, 2005 (JP) 2005-161027

(51) Int. Cl. B60T 8/1755

(52) U.S. Cl. 701/70

(57) ABSTRACT

A vehicle target braking/driving force and a vehicle target yaw moment to be achieved by a control of braking/driving force of each wheel are-calculated. The target yaw moment is corrected, for example, so as to coincide with the product of the correction coefficient determined based upon, the weight of the whole vehicle, the longitudinal and lateral distribution ratios of wheel vertical loads, and vehicle turning direction, and the target yaw moment, whereby the target yaw moment is corrected in accordance with the weight of the whole vehicle, the position of center of gravity of the whole vehicle, and vehicle turning direction. The final target braking/driving force and target yaw moment that can be achieved by the control of the braking/driving force of each wheel are calculated on the basis of the target braking/driving force and the target yaw moment after the correction, and the braking/driving force of each wheel is controlled so as to achieve the final target braking/driving force and target yaw moment.

### TECHNICAL FIELD

The present invention relates to a vehicle braking/driving force control apparatus, and more particularly to a vehicle braking/driving force control apparatus that controls braking/driving force of each wheel.

### BACKGROUND ART

As one of braking/driving force control apparatuses for a vehicle, such as an automobile, for controlling braking/driving force of each wheel, there has conventionally been known a driving force control apparatus for controlling driving force of each wheel according to a vertical load of each wheel, as disclosed in the Japanese Patent No. 2795445, for example. This braking/driving force control apparatus can enhance running stability of a vehicle compared to the case where the driving force of each wheel is not controlled according to the vertical load of each wheel.

It is considered that, in order to further enhance running stability of a vehicle that can control braking/driving force of each wheel, vehicle braking/driving force and vehicle yaw moment are controlled by controlling the braking/driving force of each wheel. However, the yaw moment that should be applied to the vehicle through the control of braking/driving force of each wheel varies depending upon a boading condition, loading condition, turning direction, or the like.

In general, the weight of the whole vehicle changes and the position of the center of gravity of the vehicle, seen from the top of the vehicle, changes in the longitudinal and lateral directions, depending upon the boading condition or loading condition of the vehicle. As the weight of the whole vehicle increases, the inertia mass increases, that makes the vehicle steering characteristic tend to be in an under-steer state. Further, the position of the center of gravity is made close to the rear wheels with the increase of the number of occupant, which makes the vehicle steering characteristic tend to be in an over-steer state. Therefore, the magnitude of the yaw moment that should be applied to the vehicle decreases.

Since the driver's seat of the vehicle is positioned on the right side and the steering apparatus is also positioned on the right side in the vehicle in the case of a right-hand drive vehicle, the position of center of gravity of the whole vehicle seen from the top of the vehicle is positioned on the right side to the center of the vehicle. Accordingly, when the vehicle turns in the leftward direction, the steering characteristic of the vehicle tends to be under-steer, compared to the case where the vehicle turns in the rightward direction, and when the vehicle turns in the leftward direction, the yaw moment that should be applied to the vehicle is great compared to the case where the vehicle turns in the rightward direction. Further, the magnitude of the yaw moment that should be increased or decreased according to the turning direction of the vehicle also changes with the change of the position of the center of gravity of the vehicle in the lateral direction caused by the change in the boading condition or loading condition of the vehicle.

Accordingly, in the conventional braking/driving force control apparatus described above, a full consideration is not given to the fact that the yaw moment which should be applied to the vehicle through the control of the braking/driving force of each wheel for enhancing running stability of the vehicle varies depending upon the boading condition, loading condition, or turning direction of the vehicle. Therefore, it is necessary to make an improvement for further enhancing running stability of the vehicle by controlling the braking/driving force and the yaw moment of the vehicle through the control of braking/driving force of each wheel. Since the vertical load of each wheel varies depending upon the boading condition or loading condition of the vehicle, the driving force of each wheel is consequently controlled in accordance with the boading condition or loading condition of the vehicle in the above-mentioned conventional braking/driving force control apparatus. However, it cannot control the braking/driving force of each wheel so as to apply the optimum yaw moment to the vehicle according to the boading condition or loading condition or turning condition of the vehicle.

### DISCLOSURE OF THE INVENTION

In view of the circumstance described above in the conventional vehicle braking/driving force control apparatus that is configured to control braking/driving force and yaw moment of the vehicle through the control of the braking/driving force of each wheel, the present invention gives attention to the variation of the magnitude of the yaw moment that should be applied to the vehicle depending upon the boading condition, loading condition and turning direction of the vehicle, and a main object of the present invention is to stably drive a vehicle, regardless of the boading condition, loading condition, and turning direction of the vehicle, by controlling the braking/driving force of each wheel with the consideration of the variation in the magnitude of the yaw moment that should be applied to the vehicle.

The present invention provides a vehicle braking/driving force control apparatus comprising braking/driving force applying means that can apply different braking/driving force to at least each of a pair of right and left wheels; means for detecting an amount of driving operation by an occupant; means for calculating a vehicle target braking/driving force and a vehicle target yaw moment, which should be generated by the braking/driving forces of the wheels, on the basis of at least the driving operation amount; and control means for controlling the braking/driving forces applied to the wheels by the braking/driving force applying means so as to achieve the target braking/driving force and the target yaw moment, wherein the apparatus further comprises means for obtaining the weight of the whole vehicle and correcting the target yaw moment in accordance with the weight of the whole vehicle.

With this configuration, the weight of the whole vehicle is obtained, and the vehicle target yaw moment that should be generated by the braking/driving forces of the wheels is corrected in accordance with the weight of the whole vehicle, whereby the yaw moment applied to the vehicle is increased or decreased in accordance with the weight of the whole vehicle, with the result that the vehicle can stably run regardless of the variation in the weight of the whole vehicle caused by the change in the number of the occupant(s) or loading condition.

Further, the present invention provides a vehicle braking/driving force control apparatus comprising braking/driving force applying means that can apply different braking/driving force to at least each of a pair of right and left wheels; means for detecting an amount of driving operation by an occupant; means for calculating a vehicle target braking/driving force and a vehicle target yaw moment, which should be generated by the braking/driving forces of the wheels, on the basis of at least the driving operation amount; and control means for controlling the braking/driving forces applied to the wheels by the braking/driving force applying means so as to achieve the target braking/driving force and the target yaw moment, wherein the apparatus further comprises means for estimating the position of the center of gravity of the whole vehicle and correcting the target yaw moment in accordance with the position of the center of gravity of the whole vehicle.

With this configuration, the position of the center of gravity of the whole vehicle is estimated, and the vehicle target yaw moment that should be generated by the braking/driving forces of the wheels is corrected in accordance with the position of the center of gravity of the whole vehicle, whereby the yaw moment applied to the vehicle is increased or decreased in accordance with the position of the center of gravity of the whole vehicle, with the result that the vehicle can stably run regardless of the variation in the position of the center of gravity of the whole vehicle caused by the change in the number of the occupant(s), the position of the occupant(s), or loading condition.

Further, the present invention provides a vehicle braking/driving force control apparatus comprising braking/driving force applying means that can apply different braking/driving force to at least each of a pair of right and left wheels; means for detecting an amount of driving operation by an occupant; means for calculating a vehicle target braking/driving force and a vehicle target yaw moment, which should be generated by the braking/driving forces of the wheels, on the basis of at least the driving operation amount; and control means for controlling the braking/driving forces applied to the wheels by the braking/driving force applying means so as to achieve the target braking/driving force and the target yaw moment, wherein the apparatus further comprises means for determining the turning direction of the vehicle, and correcting the target yaw moment in accordance with the turning direction of the vehicle.

With this configuration, the turning direction of the vehicle is determined, and the target yaw moment of the vehicle that should be generated by the braking/driving forces of the wheels is corrected in accordance with the turning direction of the vehicle, whereby the yaw moment applied to the vehicle is optimally controlled in accordance with the turning direction of the vehicle, even if the position of center of gravity of the whole vehicle is shifted in the leftward or rightward direction from the center of the vehicle. Accordingly, the vehicle can stably run regardless of the vehicle turning direction.

In the above-mentioned configurations, the braking/driving force control apparatus according to the present invention may comprise means for modifying the target braking/driving force and/or the target yaw moment after the correction such that the magnitude of the vehicle braking/driving force and/or the magnitude of the yaw moment may be maximized as much as possible within the range of the braking/driving force and the yaw moment that can be achieved by the braking/driving forces of the wheels, in case where the target braking/driving force and/or the target yaw moment after the correction cannot be achieved by the braking/driving forces of the wheels.

With this configuration, in case where the target braking/driving force and/or the target yaw moment after the correction cannot be achieved by the braking/driving forces of the wheels, at least the target braking/driving force or the target yaw moment after the correction is corrected such that the magnitude of the vehicle braking/driving force and/or the magnitude of the yaw moment may be maximized as much as possible within the range of the braking/driving force and the yaw moment that can be achieved by the braking/driving forces of the wheels, whereby the braking/driving force and the yaw moment close to the values necessary for stably driving the vehicle can surely be applied to the vehicle.

In the above-mentioned configurations, the means for correcting the target yaw moment may correct the target yaw moment so as to increase the magnitude thereof when the weight of the whole vehicle is great, compared to the case where the weight of the whole vehicle is small.

In the above-mentioned configurations, the means for correcting the target yaw moment may correct the target yaw moment so as to increase the magnitude thereof when the degree of the deviation of the position of the center of gravity close to the rear wheels is great, compared to the case where the degree of the deviation of the position of the center of gravity close to the rear wheels is small.

In the above-mentioned configuration, the means for correcting the target yaw moment may determine the degree of the deviation of the position of center of gravity close to the rear wheels on the basis of the ratio of the vertical loads of the front wheels and the rear wheels.

In the above-mentioned configurations, the means for correcting the target yaw moment may obtain the lateral deviation of the position of center of gravity of the whole vehicle from the center of the vehicle, and correct the target yaw moment so as to increase the magnitude thereof when the vehicle turns in the direction opposite to the direction of the lateral deviation of the position of center of gravity of the whole vehicle, compared to the case where the vehicle turns in the direction same as the direction of the lateral deviation of the position of center of gravity.

In the above-mentioned configuration, the means for correcting the target yaw moment may determine the lateral deviation of the position of center of gravity of the whole vehicle on the basis of the ratio of the vertical loads on the right wheels and the left wheels.

In the above-mentioned configurations, the means for correcting the target yaw moment may obtain the weight of the whole vehicle, the position of center of gravity of the whole vehicle, and the turning direction of the vehicle, and correct the target yaw moment on the basis of the weight of the whole vehicle, the position of center of gravity of the whole vehicle, and the turning direction of the vehicle.

In the above-mentioned configurations, the braking/driving force control apparatus according to the present invention may control the braking/driving force applied to each wheel by the braking/driving force applying means such that the vehicle braking/driving force and the target yaw moment by the braking/driving forces of the wheels become the greatest within the range where the ratio of the vehicle braking/driving force and the target yaw moment by the braking/driving forces of the wheels becomes substantially the ratio of the target braking/driving force and the target yaw moment, when the target braking/driving force and/or the target yaw moment cannot be achieved by the braking/driving forces of the wheels.

In the above-mentioned configurations, the braking/driving force applying means may comprise means for applying driving force to each of the right and left wheels independently, and means for applying braking force to each wheel independently.

In the above-mentioned configurations, the braking/driving force applying means may comprise means for applying common driving force to the right and left wheels, means for controlling the distribution of the driving force to the right and left wheels, and means for applying braking force to each wheel independently.

In the above-mentioned configurations, the means for applying driving force may be composed of means for applying common driving force to the right and left front wheels, and means for applying common driving force to the right and left rear wheels.

In the above-mentioned configurations, the braking/driving force applying means may comprise means for applying common driving force to the right and left front wheels and the right and left rear wheels, means for controlling the distribution of the driving force to the front and rear wheels, means for controlling the distribution of the driving force to the right and left front wheels, and means for controlling the distribution of the driving force to the right and r left ear wheels.

In the above-mentioned configurations, the means for applying driving force may comprise an electric motor generator.

In the above-mentioned configuration, the electric motor generator may perform regenerative braking upon the braking.

In the above-mentioned configurations, the means for calculating the vehicle target braking/driving force and the vehicle target yaw moment may calculate a target longitudinal acceleration and a target yaw rate of the vehicle for stably running the vehicle on the basis of at least the amount of driving operation by an occupant, and may calculate the vehicle target driving/braking force and the vehicle target yaw moment on the basis of the target longitudinal acceleration and the target yaw rate of the vehicle.

In the above-mentioned configurations, the control means may calculate the target braking/driving force of each wheel on the basis of the vehicle target braking/driving force, the vehicle target yaw moment, and the distribution ratio of the braking/driving force to the front and rear wheels, and may control the braking/driving force applied to each wheel on the basis of the target braking/driving force of each wheel.

### BRIEF DESCRIPTION OF DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a schematic block diagram showing a braking/driving force control apparatus applied to a right-hand four-wheel drive vehicle of a wheel-in-motor type according to a first embodiment of the present invention;

FIG. 2 is an explanatory view for explaining various cases of the relationship between braking/driving force of each wheel and vehicle braking/driving force and the relationship between braking/driving force of each wheel and yaw moment;

FIG. 3 is a flowchart showing a braking/driving force control routine executed by the electronic controller for controlling driving force in the first embodiment;

FIG. 4A is a graph showing the range, that can be achieved by the control of the braking/driving force of each wheel, of the braking/driving force and yaw moment of the vehicle;

FIG. 4B is an explanatory view showing a manner of a calculation of a vehicle target braking/driving force Fvt and a vehicle target yaw moment Mvt in case where a vehicle target braking/driving force Fvn and a vehicle target yaw moment Mvn are outside the range that can be achieved by the control of the braking/driving force of each wheel;

FIG. 4C is an explanatory view showing the range, that can be achieved by the control of the braking/driving force of each wheel, of the target braking/driving force Fvt and the target yaw moment Mvt in the vehicle having a driving source provided only at the right and left front wheels or at the right and left rear wheels;

FIG. 5 is a graph showing a relationship between a weight W of the whole vehicle and a correction coefficient Kw;

FIG. 6 is a graph showing a relationship between a longitudinal distribution ratio Rx of wheel vertical loads and a correction coefficient Kx;

FIG. 7 is a graph showing a relationship between a lateral distribution ratio Ry of wheel vertical loads and a turning direction of the vehicle, and a correction coefficient Ky;

FIG. 8 is a schematic block diagram showing a braking/driving force control apparatus applied to a right-hand four-wheel drive vehicle in which driving force and regenerative braking force from a single electric motor generator, which is common to four wheels, are controlled so as to be distributed to the four wheels according to a second embodiment of the present invention;

FIG. 9 is an explanatory view for explaining various cases of the relationship between braking/driving force of each wheel and vehicle braking/driving force and the relationship between braking/driving force of each wheel and yaw moment of the vehicle in the second embodiment;

FIG. 10 is an explanatory view for explaining other various cases of the relationship between braking/driving force of each wheel and vehicle braking/driving force and the relationship between braking/driving force of each wheel and yaw moment of the vehicle in the second embodiment;

FIG. 11 is a flowchart showing a braking/driving force control routine executed by the electronic controller for controlling driving force in the second embodiment;

FIG. 12A is a graph showing the range, that can be achieved by the control of the braking/driving force of each wheel, of the braking/driving force and yaw moment of the vehicle;

FIG. 12B is an explanatory view showing a manner of a calculation of a vehicle target braking/driving force Fvt and a vehicle target yaw moment Mvt in case where a vehicle target braking/driving force Fvn and a vehicle target yaw moment Mvn are outside the range that can be achieved by the control of the braking/driving force of each wheel; and

FIG. 12C is an explanatory view showing the range, that can be achieved by the control of the braking/driving force of each wheel, of the target braking/driving force Fvt and the target yaw moment Mvt in the vehicle having a driving source provided only at the right and left front wheels or at the right and left rear wheels.

### BEST MODE FOR CARRYING OUT OF THE INVENTION

Some preferred embodiments of the present invention will be explained in detail with reference to the accompanying drawings.

### First Embodiment

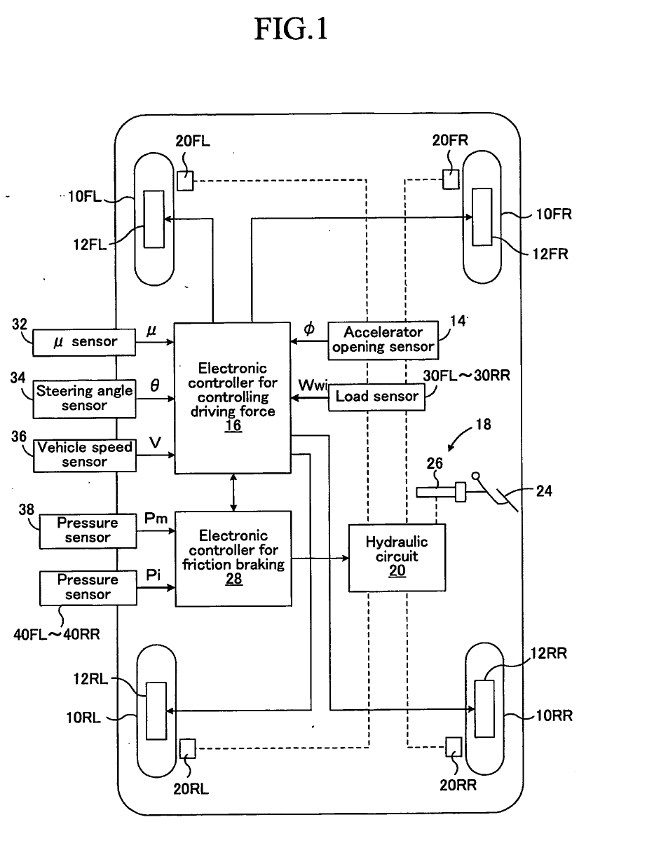

FIG. 1 is a schematic block diagram showing a braking/driving force control apparatus applied to a right-hand four-wheel drive vehicle of a wheel-in-motor type according to a first embodiment of the present invention.

In FIG. 1, numerals 10FL and 10FR respectively represent left and right front wheels that are steering wheels, and numerals 10RL and 10RR respectively represent left and right rear wheels that are non-steering wheels. Electric motor generators 12FL and 12FR that are in-wheel motors are incorporated into the left and right front wheels 10FL and 10FR respectively, whereby the left and right front wheels 10FL and 10FR are driven by the electric motor generators 12FL and 12FR. The electric motor generators 12FL and 12FR also function as regenerative electric generators for each of the left and right front wheels upon the braking, so that they generate regenerative braking force.

Similarly, electric motor generators 12RL and 12RR that are in-wheel motors are incorporated into the left and right rear wheels 10RL and 10RR respectively, whereby the left and right front wheels 10RL and 10RR are driven by the electric motor generators 12RL and 12RR. The electric motor generators 12RL and 12RR also function as regenerative electric generators for each of the left and right rear wheels upon the braking, so that they generate regenerative braking force.

The driving force from each of the electric motor generators 12FL to 12RR is controlled by an electronic controller 16 for controlling driving force on the basis of an accelerator opening φ that is a step-on amount of an accelerator pedal, that is not shown in FIG. 1, detected by an accelerator opening sensor 14. The regenerative braking force from each of the electric motor generators 12FL to 12RR is also controlled by the electronic controller 16 for controlling driving force.

Although not shown in FIG. 1 in detail, the electronic controller 16 for controlling driving force is composed of a microcomputer and a driving circuit, wherein the microcomputer may have a general configuration to include, for example, a CPU, ROM, RAM, and input/output port device, those of which are interconnected with one another via a bi-directional common bus. In a normal running, electric power charged in a battery, which is not shown in FIG. 1, is supplied to each of the electric motor generators 12FL to 12RR, and upon the deceleration and braking of the vehicle, the electric power generated by the regenerative braking by each of the electric motor generators 12FL to 12RR is charged to the battery via the driving circuit.

The friction braking forces of the left and right front wheels 10FL and 10FR and the left and right rear wheels 10RL and 10RR are controlled by controlling braking pressures of corresponding wheel cylinders 22FL, 22FR, 22RL and 22RR by a hydraulic circuit 20 in a friction braking device 18. Although not shown in the figure, the hydraulic circuit 20 includes a reservoir, oil pump, and other various valve devices. In a normal situation, the braking pressure of each wheel cylinder is controlled in accordance with the step-on amount of the brake pedal 24 by a driver and the pressure of a master cylinder 26 that is driven in accordance with the step-on operation of the brake pedal 24. It is controlled as necessary through the control of the oil pump or various valve devices by an electronic controller 28 for controlling braking force, regardless of the step-on amount of the brake pedal 24 by a driver.

Although not shown in FIG. 1 in detail, the electronic controller 18 for controlling braking force is also composed of a microcomputer and a driving circuit, wherein the microcomputer may have a general configuration to include, for example, a CPU, ROM, RAM, and input/output port device, those of which are interconnected with one another via a bi-directional common bus.

Inputted to the electronic controller 16 for controlling driving force are signals indicating vertical loads Wwi (i=fl, fr, rl, rr) of the corresponding wheels from pressure sensors 30FL to 30RR; a signal indicating a road friction coefficient μ from μ sensor 32; a signal indicating a steering angle θ from a steering angle sensor 34; and a signal indicating a vehicle speed V from a vehicle speed sensor 36, in addition to the signal indicating the accelerator opening φ from the accelerator opening sensor 14. Inputted to the electronic controller 28 for controlling braking force are a signal indicating a master cylinder pressure Pm from a pressure sensor 38 and signals indicating braking pressures (wheel cylinder pressures) Pbi (i=fl, fr, rl, rr) of corresponding wheels from pressure sensors 39FL to 39RR. The electronic controller 16 for controlling driving force and the electronic controller 28 for controlling braking force exchange signals with each other according to need. Note that the steering angle sensor 34 detects a steering angle θ with the leftward turning direction of the vehicle defined as a positive.

The electronic controller 16 for controlling driving force calculates a vehicle target longitudinal acceleration Gxt on the basis of the accelerator opening φ and the master cylinder pressure Pm, which indicate an amount of acceleration/deceleration operation by a driver, and calculates a target yaw rate γt of the vehicle on the basis of the steering angle θ, which is a steering operation amount by a driver, and the vehicle speed V through a manner well-known in this technical field. Then, the electronic controller 16 for controlling driving force calculates a target braking/driving force Fvn that is required to the vehicle on the basis of the vehicle target longitudinal acceleration Gxt, and calculates a target total yaw moment Mvnt required to the vehicle on the basis of the vehicle target yaw rate γt.

The electronic controller 16 for controlling driving force calculates the vehicle slip angle β with a manner well-known in this technical field, calculates the slip angle α of the left and right front wheels on the basis of the vehicle slip angle β and the steering angle θ, and calculates a vehicle turning yaw moment Ms due to a lateral force of each wheel on the basis of the slip angle α. Then, the electronic controller 16 for controlling driving force calculates the value obtained by subtracting the turning yaw moment Ms from the vehicle target total yaw moment Mvnt as the vehicle target yaw moment Mvn, required to the vehicle, through the control of the braking/driving force of each wheel.

Further, the electronic controller 16 for controlling driving force calculates the weight W of the whole vehicle, the longitudinal distribution ratio Rx of the wheel vertical loads, and the lateral distribution ratio Ry of the wheel vertical loads based upon the vertical load Wwi of each wheel, calculates correction coefficients Kw, Kx and Ky on the basis of the weight W of the whole vehicle, the longitudinal distribution ratio Rx, the lateral distribution ratio Ry, and the vehicle turning direction, and corrects the target yaw moment Mvn so as to increase or decrease in accordance with the weight of the whole vehicle, the position of center of gravity of the whole vehicle and the vehicle turning direction, by correcting the vehicle target yaw moment Mvn to the product of the correction coefficients Kw, Kx and Ky and the vehicle target yaw moment Mvn.

The electronic controller 16 for controlling driving force further calculates the vehicle maximum driving force Fvdmax and the vehicle maximum braking force Fvbmax attainable by the braking/driving forces of the wheels on the basis of the road friction coefficient μ, and calculates the vehicle maximum yaw moment Mvlmax in the leftward turning direction and the vehicle maximum yaw moment Mvrmax in the rightward direction by the braking/driving forces of the wheels on the basis of the road friction coefficient μ.

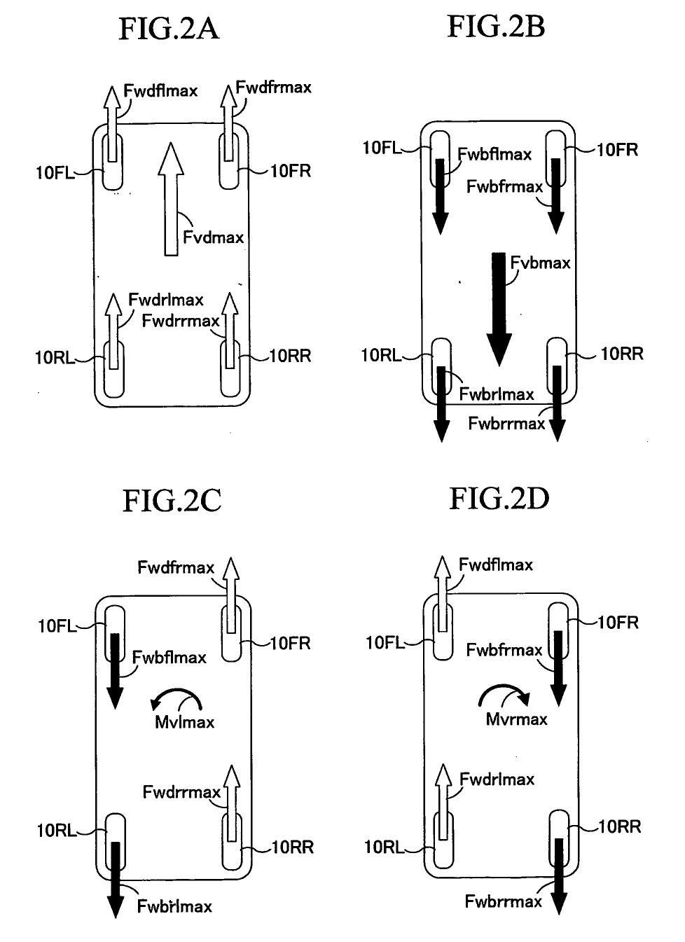

As shown in FIG. 2A, supposing that the vertical load and the friction coefficients to the road surface of the wheels are the same, and the sizes of the friction circles of the wheels are the same, the vehicle maximum driving force Fvdmax under the condition where the yaw moment by the braking/driving forces of the wheels is not acted on the vehicle is achieved when the braking/driving forces Fwxfl and Fwxfr of the left and right front wheels 10FL and 10FR are the maximum driving forces Fwdflmax and Fwdfrmax and the braking/driving forces Fwxrl and Fwxrr of the left and right rear wheels 10RL and 10RR are the maximum driving forces Fwdfrmax and Fwdrrmax. Similarly, as shown in FIG. 2B, the vehicle maximum braking force Fvbmax under the condition where the yaw moment by the braking/driving forces of the wheels is not acted on the vehicle is achieved when the braking/driving forces Fwxfl and Fwxfr of the left and right front wheels 10FL and 10FR are the maximum braking forces Fwbflmax and Fwbfrmax and the braking/driving forces Fwxrl and Fwxrr of the left and right rear wheels 10RL and 10RR are the maximum braking forces Fwbrlmax and Fwbrrmax.

As shown in FIG. 2C, the vehicle maximum yaw moment Mvlmax in the leftward turning direction under the condition where the longitudinal force by the braking/driving forces of the wheels is not acted on the vehicle is achieved when the braking/driving forces Fwxfl and Fwxrl of the front left and rear left wheels 10FL and 10RL are the maximum braking forces Fwbflmax and Fwbrlmax and the braking/driving forces Fwxfr and Fwxrr of the front right and rear right wheels 10FR and 10RR are the maximum driving forces Fwdfrmax and Fwdrrmax. Similarly, as shown in FIG. 2D, the vehicle maximum yaw moment Mvrmax in the rightward turning direction under the condition where the longitudinal force by the braking/driving forces of the wheels is not acted on the vehicle is achieved when the braking/driving forces Fwxfl and Fwxrl of the front left and rear left wheels 10FL and 10RL are the maximum driving forces Fwdflmax and Fwdrlmax and the braking/driving forces Fwxfr and Fwxrr of the front right and rear right wheels 10FR and 10RR are the maximum braking forces Fwbfrmax and Fwbrrmax.

In case where the output torque of each of the electric motor generators 12FL to 12RR is sufficiently great, the maximum driving force and the maximum braking force of each wheel are determined by the road friction coefficient μ, so that, with the vehicle accelerating direction and vehicle leftward turning direction defined as positive, the following relationships are established between the maximum driving force and the maximum braking force of each wheel, the vehicle maximum driving force and the vehicle maximum braking force, and the vehicle maximum yaw moment in the leftward turning direction and the vehicle maximum yaw moment in the rightward turning direction.

Fwdflmax=Fwdfrmax=−Fwbflmax=−Fwbfrmax

Fwdrlmax=Fwdrrmax=−Fwbrlmax=−Fwbrrmax

Fvdmax=−Fvbmax

Mvlmax=−Mvrmax

Since the maximum driving force Fwdimax and the maximum braking force Fwbimax (i=fl, fr, rl, rr) of each wheel are determined by the road friction coefficient μ, the vehicle maximum driving force Fvdmax, vehicle maximum braking force Fvbmax, vehicle maximum yaw moment Mvlmax in the leftward turning direction, and vehicle maximum yaw moment Mvrmax in the rightward turning direction are also determined by the road friction coefficient μ. Accordingly, if the road friction coefficient μ is found, the vehicle maximum driving force Fvdmax and the other aforesaid values can be estimated.

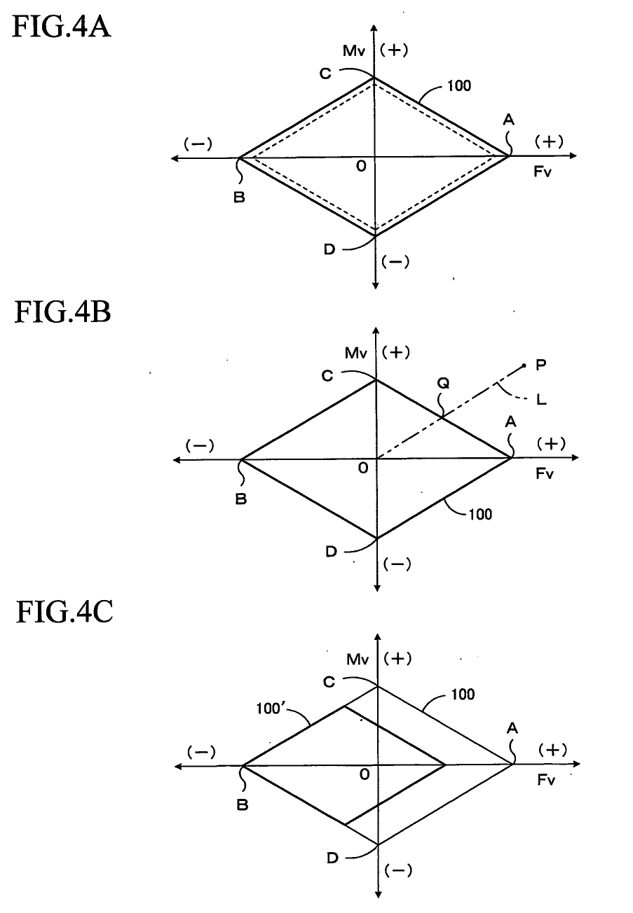

As shown in FIG. 4A, in a rectangular coordinate with the vehicle driving/braking force Fvx as abscissa and the vehicle yaw moment Mv as ordinate, the vehicle braking/driving force Fvx and the vehicle yaw moment Mv that can be achieved by the control of the braking/driving force of each wheel take values within a diamond quadrangle 100 decided by the vehicle maximum driving force Fvdmax, vehicle maximum braking force Fvbmax, vehicle maximum yaw moment Mvlmax in the leftward turning direction, and vehicle maximum yaw moment Mvrmax in the rightward turning direction.

Notably, in FIG. 4, points A to D correspond to the cases A to D in FIG. 2, wherein the coordinates at the points A to D are (Fvdmax, 0), (Fvbmax, 0), (0, Mvlmax), and (0, Mvrmax), respectively. As shown by a broken line in FIG. 4A, the quadrangle 100 becomes small as the road friction coefficient μ decreases. Further, as the steering angle θ increases, the lateral force of front left and front right wheels, that are steering wheels, increases, so that the allowance of the longitudinal force becomes small. Therefore, the quadrangle 100 becomes small as the magnitude of the steering angle θ increases.

Supposing that the longitudinal distribution ratio of the braking/driving force Fv to the rear wheels is defined as Kr (constant of 0<Kr<1), and the vehicle tread is defined as Tr, the following equations 1 to 3 are established. Accordingly, the electronic controller 16 for controlling driving force sets the vehicle target braking/driving force Fvt and the vehicle target yaw moment Mvt by the control of the braking/driving force of each wheel to the target braking/driving force Fvn and the vehicle target yaw moment Mvn, when the vehicle target braking/driving force Fvn and the vehicle target yaw moment Mvn are within the above-mentioned quadrangle 100. For example, it calculates the values satisfying the following equations 1 to 3 as the target braking/driving forces Fwxti (i=fl, fr, rl, rr) of the wheels by the least square method.

Fwxfl+Fwxfr+Fwxrl+Fwxrr=Fvt (1).

{Fwxfr+Fwxrr−(Fwxfl+Fwxrl)}Tr/2=Mvt (2)

(Fwxfl+Fwxfr)Kr=(Fwxrl+Fwxrr)(1−Kr) (3)

When the vehicle target braking/driving force Fvn and the vehicle target yaw moment Mvn are outside the range of the above-mentioned quadrangle 100, the electronic controller 16 for controlling driving force calculates the vehicle target braking/driving force Fvt and the vehicle target yaw moment Mvt such that the magnitude of the vehicle braking/driving force Fv and the magnitude of the yaw moment Mv by the target braking/driving forces Fwxti of the wheels become respectively the maximum within the range where the ratio of the vehicle target braking/driving force Fvt and the yaw moment Mvt by the braking/driving forces of the wheels becomes the ratio of the target braking/driving force Fvn and the target yaw moment Mvn, required to the vehicle, by the braking/driving forces of the wheels. Then, the electronic controller 16 for controlling driving force calculates the values satisfying the foregoing equations 1 to 3 as the target braking/driving forces Fwxti of the wheels by the least square method, for example.

When the target braking/driving force Fwxti of each wheel takes a positive value that means it is a driving force, the electronic controller 16 for controlling driving force sets the target friction braking force Fwbti and the target regenerative braking force Fwrti (i=fl, fr, rl, rr) of each wheel to zero, outputs the signals indicating the target friction braking forces Fwbti to an electronic controller 28 for controlling braking force, sets the target driving force Fwdti (i=fl, fr, rl, rr) of each wheel to the associated target braking/driving force Fwxti, calculates the target driving currents Iti (i=fl, fr, rl, rr) to the electric motor generators 12FL to 12RR by unillustrated maps or functions on the basis of the target driving forces Fwdti, and controls the driving currents applied to the electric motor generators 12FL to 12RR on the basis of the target driving currents Iti, thereby controlling the driving force of each wheel such that the driving/braking force Fwxi of each wheel becomes the associated target braking/driving force Fwxti.

On the other hand, when the target braking/driving force Fwxti of each wheel takes a negative value which means that the target braking/driving force Fwxti is a braking force and the target braking/driving force Fwxti is not more than the maximum regenerative braking force of each wheel, the electronic controller 16 for controlling driving force sets the target driving force Fwdti and the target friction braking force Fwbti of each wheel to zero, sets the target regenerative braking force Fwrti to the target braking/driving force Fwxti, and controls the electric motor generators 12FL to 12RR such that the regenerative braking force becomes the target regenerative braking force Fwrti.

When the target braking/driving force Fwxti of each wheel takes a negative value which means that the target braking/driving force Fwxti is a braking force and the target braking/driving force Fwxti is greater than the maximum regenerative braking force of each wheel, the electronic controller 16 for controlling driving force sets the target driving force Fwdti of each wheel to zero, sets the target regenerative braking force Fwrti of each wheel to the maximum regenerative braking force Fwxrimax (i=fl, fr, rl, rr), and controls the electric motor generators 12FL to 12RR such that the regenerative braking force becomes the maximum regenerative braking force Fwxrimax. Further, it calculates the braking force that corresponds to the difference between the target braking/driving force Fwxti and the maximum regenerative braking force Fwxrimax as the target friction braking force Fwbti (i=fl, fr, rl, rr), and outputs the signals indicating the target friction braking forces Fwbti of the wheels to the electronic controller 28 for controlling braking force.

The electronic controller 28 for controlling braking force calculates the target braking pressure Pbti (i=fl, fr, rl, rr) of each wheel on the basis of the target friction braking force Fwbti of each wheel inputted from the electronic controller 16 for controlling driving force, and controls the hydraulic circuit 20 such that the braking pressure Pbi of each wheel becomes the associated target braking pressure Pbti, and the friction braking force Fwbi (i=fl, fr, rl, rr) of each wheel thereby becomes the associated target friction braking force Fwbti of each wheel.

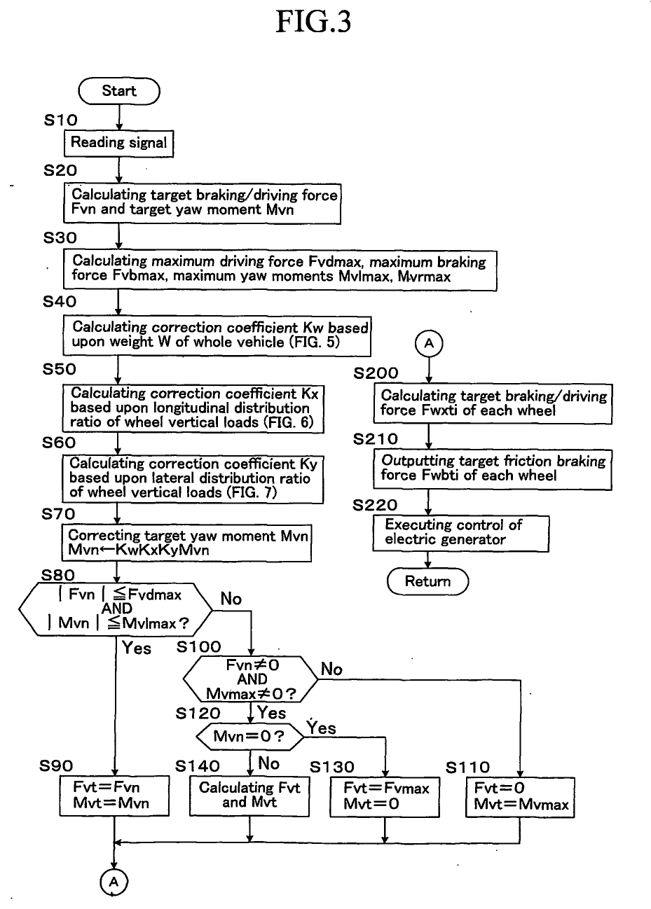

The braking/driving force control achieved by the electronic controller 16 for controlling driving force in the first embodiment will now be explained with reference to the flowchart shown in FIG. 3. The control by the flowchart shown in FIG. 3 is started by the activation of the electronic controller 16 for controlling driving force, and it is repeatedly executed every predetermined time until an ignition switch, not shown, is turned off.

At Step 10, the signals indicating the accelerator opening φ detected by the accelerator opening sensor 14 and the like are firstly read. At Step 20, the vehicle target braking/driving force Fvn and vehicle target yaw moment Mvn that are required to the vehicle and caused by the control of the braking/driving force of each wheel are calculated in the aforesaid manner on the basis of the accelerator opening φ and the like.

At Step 30, the vehicle maximum driving force Fvdmax, vehicle maximum braking force Fvbmax, vehicle maximum yaw moment Mvlmax in the leftward turning direction, and vehicle maximum yaw moment Mvrmax in the rightward direction, attainable by the braking/driving force of each wheel, are calculated by maps or functions, not shown, on the basis of the road friction coefficient μ. Specifically, the points A to D shown in FIG. 4 are specified.

At Step 40, the weight W of the whole vehicle is calculated on the basis of the vertical load Wwi of each wheel detected by each load sensor, and calculates the correction coefficient Kw based upon the weight W of the whole vehicle from the map corresponding to the graph shown in FIG. 5 based upon the weight W of the whole vehicle. As shown in FIG. 5, the correction coefficient Kw is calculated so as to increase with the increase in the weight W of the whole vehicle. In FIG. 5, Wo is the weight of the whole vehicle in case where only a driver is on the vehicle and luggage is not loaded.

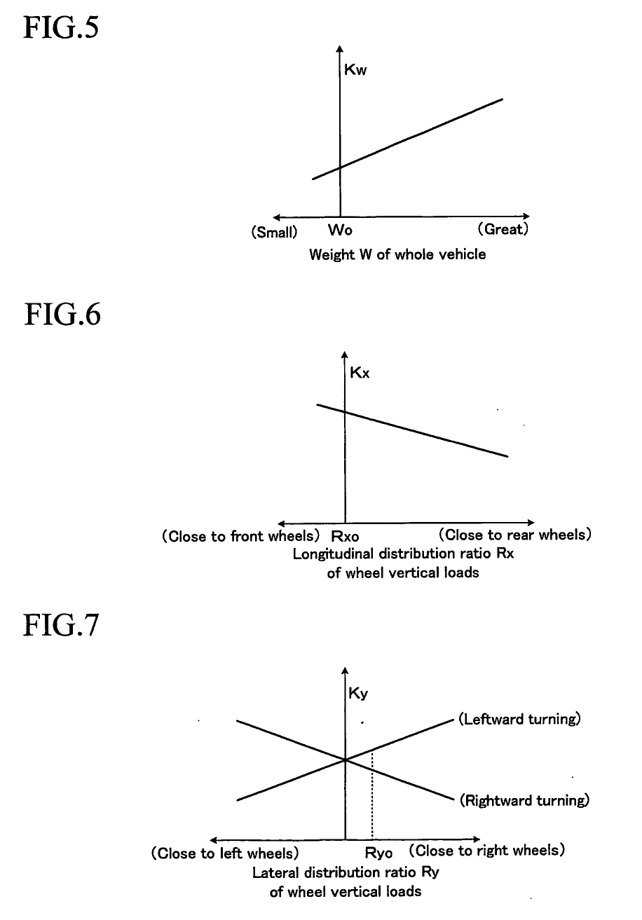

At Step 50, the longitudinal vehicle distribution ratio Rx of the wheel vertical loads (the ratio of the vertical load Wf of the front left and front right wheels to the vertical load Wr of the rear left and rear right wheels) is calculated on the basis of the vertical load Wwi of each wheel, and the correction coefficient Kx based upon the longitudinal distribution ratio Rx of the wheel vertical loads is calculated by a map corresponding to the graph shown in FIG. 6 based upon the longitudinal distribution ratio Rx of the wheel vertical loads. As shown in FIG. 6, the correction coefficient Kx is calculated so as to increase as the longitudinal distribution ratio Rx of the wheel vertical loads is shifted toward the rear-wheel-side. In FIG. 6, Rxo is the longitudinal distribution ratio of the wheel vertical loads in case where only a driver is on the vehicle and luggage is not loaded.

At Step 60, the vehicle turning direction is determined on the basis of the steering angle θ (or vehicle yaw rate or vehicle lateral acceleration), the lateral distribution ratio Ry of the wheel vertical loads (the ratio of the vertical load Wr of the front right and rear right wheels to the vertical load Wl of the front left and rear left wheels) is calculated on the basis of the vertical load Wwi of each wheel, and the correction coefficient Ky based upon the lateral distribution ratio Ry of the wheel vertical loads is calculated by a map corresponding to the graph shown in FIG. 7 based upon the lateral distribution ratio Ry of the wheel vertical loads and the vehicle turning direction. As shown in FIG. 7, the correction coefficient Ky is calculated so as to increase as the lateral distribution ratio Ry of the wheel vertical loads is shifted to the right-wheel-side and so as to decrease as the lateral distribution ratio Ry of the wheel vertical loads is shifted to the left-wheel-side, upon the leftward turning, while it is calculated so as to decrease as the lateral distribution ratio Ry of the wheel vertical loads is shifted to the right-wheel-side and so as to increase as the lateral distribution ratio Ry of the wheel vertical loads is shifted to the left-wheel-side, upon the rightward turning. In FIG. 7, Ryo is the lateral distribution ratio of the wheel vertical loads in case where only a driver is on the vehicle and luggage is not loaded.

At Step 70, the vehicle target yaw moment Mvn is corrected to the product of the correction coefficients Kw, Kx and Ky and the vehicle target yaw moment Mvn calculated at Step S20, and then, the program proceeds to Step 80.

At Step 80, it is determined whether or not the absolute value of the target braking/driving force Fvn is not more than the vehicle maximum driving force Fvdmax and the absolute value of the vehicle target yaw moment Mvn is not more than the vehicle maximum yaw moment Mvlmax, i.e., it is determined whether the vehicle target braking/driving force Fvn and the vehicle target yaw moment Mvn are within the range of the quadrangular 100 or not and the target braking/driving force Fvn and the target yaw moment Mvn can be achieved or not through the control of the braking/driving force of each wheel. When the negative determination is made, the program proceeds to Step 100. When the positive determination is made, the vehicle target braking/driving force Fvt and the vehicle target yaw moment Mvt after the modification are respectively set to the target braking/driving force Fvn and the target yaw moment Mvn at Step 90, and then, the program proceeds to Step 200.

It is determined at Step 100 whether the target braking/driving force Fvn is zero or not and the vehicle maximum yaw moments Mvlmax and Mvrmax (correctively referred to as Mvmax) are zero or not. When it is determined that the target braking/driving force Fvn is not zero and Mvlmax and Mvrmax are not zero, the program proceeds to Step 120. When it is determined that the target braking/driving force Fvn is zero and Mvlmax and Mvrmas are zero, the vehicle target braking/driving force Fvt after the modification is set to zero and the vehicle target yaw moment Mvt after the correction is set to the maximum yaw moment Mvmax at Step 110, and then, the program proceeds to Step 200. In this case, the vehicle target yaw moment Mvt after the modification is set to the maximum yaw moment Mvlmax when the target yaw moment Mvn takes a positive value, while set to the maximum yaw moment Mvrmax when the target yaw moment Mvn takes a negative value.

It is determined at Step 120 whether the target yaw moment Mvn is zero or not. When the negative determination is made, the program proceeds to Step 140. When the positive determination is made, the vehicle target braking/driving force Fvt after the modification is set to the maximum driving force Fvdmax, when the target braking/driving force Fvn takes a positive value, while the vehicle target braking/driving force Fvt after the modification is set to the maximum braking force Fvbmax, when the target braking/driving force Fvn takes a negative value, and further, the vehicle target yaw moment Mvt after the modification is set to zero, and then, the program proceeds to Step 200.

At Step 140, the point of intersection Q of the segment L, which links the point P that shows the vehicle target braking/driving force Fvn and the vehicle target yaw moment Mvn, and the origin O and the outer line of the quadrangular 100 is obtained as the target point, as shown in FIG. 4B, and if the coordinate of the target point Q is defined as (Fvq, Mvq), the vehicle target braking/driving force Fvt after the modification and the vehicle target yaw moment Mvt after the modification are set respectively to Fvq and Mvq. Thereafter, the program proceeds to Step 200.

At Step 200, the target braking/driving force Fwxti (i=fl, fr, rl, rr) of each wheel in order to achieve the target braking/driving force Fvt and the target yaw moment Mvt is calculated in the above-mentioned manner on the basis of the vehicle target braking/driving force Fvt after the modification and the vehicle target yaw moment Mvt after the modification.

At Step 210, the target friction braking force Fwbti is calculated in the aforesaid mariner, and the signals indicating the target friction braking forces Fwbti is outputted to the electronic controller 28 for controlling braking force, whereby the electronic controller 28 for controlling braking force makes a control such that the friction braking force Fwbi of each wheel becomes the associated target friction braking force Fwbti.

At Step 220, each of the electric motor generators 12FL to 12RR is controlled such that the driving force Fwdi or the regenerative braking force Fwri of each wheel respectively becomes the target driving force Fwdti or the target regenerative braking force Fwrti.

According to the illustrated first embodiment, the vehicle target braking/driving force Fvn and the vehicle target yaw moment Mvn through the control of the braking/driving force of each wheel are calculated at Step 20, and the vehicle maximum driving force Fvdmax, vehicle maximum braking force Fvbmax, vehicle maximum yaw moment Mvlmax in the leftward turning direction, and the vehicle maximum yaw moment Mvrmax in the rightward turning direction are calculated at Step 30.

Then, at Steps 40 to 60, the correction coefficient Kw based upon the weight W of the whole vehicle, the correction coefficient Kx based upon the longitudinal distribution ratio Rx of the wheel vertical loads, the correction coefficient Ky based upon the lateral distribution ratio Ry of the wheel vertical loads and the vehicle turning direction are calculated. At Step 70, the vehicle target yaw moment Mvn is corrected to the product of the correction coefficients Kw, Kx and Ky and the vehicle target yaw moment Mvn calculated at Step 20. At Steps 80 to 140, the modified vehicle target braking/driving force Fvt and the modified vehicle target yaw moment Mvt, which can be achieved through the control of the braking/driving force of each wheel, are calculated on the basis of the vehicle target braking/driving force Fvn and the vehicle target yaw moment Mvn. At Steps 200 to 220, the braking/driving force of each wheel is controlled so as to achieve the target braking/driving force Fvt and the target yaw moment Mvt.

As is well-known by a person skilled in the art, the greater the weight W of the whole vehicle is, the greater the inertia mass of the whole vehicle becomes, so that the vehicle steering characteristic moves to the under-steer side. Further, as the longitudinal distribution ratio of the wheel vertical loads is shifted to the rear-wheel-side, the stability factor of the vehicle decreases, so that the vehicle steering characteristic moves to the over-steer side.

According to the illustrated first embodiment, the correction coefficient Kw based upon the weight W of the whole vehicle is calculated so as to increase as the weight W of the whole vehicle increases. Accordingly, the target yaw moment Mvn is corrected so as to increase as the weight W of the whole vehicle increases, whereby the optimum yaw moment can be applied to the vehicle according to the weight W of the whole vehicle to stably drive the vehicle regardless of the variation in the weight W of the whole vehicle.

Further, the correction coefficient Kx based upon the longitudinal distribution ratio Rx of the wheel vertical loads is calculated so as to increase as the longitudinal distribution ratio Rx of the wheel vertical loads is shifted to the rear-wheel-side. Accordingly, the target yaw moment Mvn is corrected so as to increase as the longitudinal distribution ratio Rx of the wheel vertical loads is shifted to the rear-wheel-side, whereby the optimum yaw moment can be applied to the vehicle according to the longitudinal distribution ratio Rx of the wheel vertical loads to stably drive the vehicle regardless of the variation in the longitudinal distribution ratio Rx of the wheel vertical loads.

Although the lateral distribution ratio Ry of the wheel vertical loads is generally shifted to the right-wheel-side in the case of the right-hand drive vehicle, the lateral distribution ratio Ry of the wheel vertical loads varies depending upon the vehicle boading condition or loading condition. As the lateral distribution ratio Ry of the wheel vertical loads is more shifted to the right-wheel-side, the vehicle steering characteristic upon the leftward turning moves to the under-steer side, while the vehicle steering characteristic upon the rightward turning moves to the over-steer side.

It is supposed that, in a two-wheel (left wheel and right wheel) vehicle model, T is defined as a vehicle tread. When the vertical loads of the left and rights wheel are respectively defined as Wl and Wr, and the cornering powers of the left and right wheels are defined as Cl and Cr respectively, the stability factor Kh is represented by the following equation 4. The following is understood from the equation 4. Specifically, the stability factor Kh increases when Wl<Wr is established, compared to the case where Wl=Wr is established, whereby the vehicle steering characteristic is moved to the under-steer side. On the contrary, the stability factor Kh decreases when Wl>Wr is established, compared to the case where Wl=Wr is established, whereby the vehicle steering characteristic is moved to the over-steer side.

Kh=(1/T)(Wr/Cr−Wl/Cl) (4)

According to the illustrated first embodiment, the correction coefficient Ky based upon the lateral distribution ratio Ry of the wheel vertical loads and the vehicle turning direction are calculated so as to increase when the lateral distribution ratio Ry of the wheel vertical loads is shifted to the right-wheel-side and to decrease when the lateral distribution ratio Ry of the wheel vertical loads is shifted to the left-wheel-side, upon the leftward turning. On the other hand, it is calculated so as to decrease when the lateral distribution ratio Ry of the wheel vertical loads is shifted to the right-wheel-side and to increase when the lateral distribution ratio Ry of the wheel vertical loads is shifted to the left-wheel-side, upon the rightward turning. Therefore, the optimum yaw moment is applied to the vehicle according to the lateral distribution ratio Ry of the wheel vertical loads, so that the vehicle is stably driven regardless of the variation in the lateral distribution ratio Ry of the wheel vertical loads and the vehicle turning direction.

In particular, in the illustrated first embodiment, it is determined at Step 80 whether or not the target braking/driving force Fvn and the target yaw moment Mvn can be achieved by the control of the braking/driving force of each wheel. When it is determined that the target braking/driving force Fvn and the target yaw moment Mvn cannot be achieved by the control of the braking/driving force of each wheel, Steps 100 to 140 are executed. When the target braking/driving force Fvn is 0, the vehicle target braking/driving force Fvt after the modification is set to 0 and the vehicle target yaw moment Mvt after the modification is set to the maximum yaw moment Mvmax at Step 110. When the target yaw moment Mvn is 0, the vehicle target braking/driving force Fvt after the modification is set to the maximum driving force Fvdmax and the vehicle target yaw moment Mvt after the modification is set to 0, in case where the target braking/driving force Fvn takes a positive value, while the vehicle target braking/driving force Fvt after the modification is set to the maximum braking force Fvbmax and the vehicle target yaw moment Mvt after the modification is set to 0, in case where the target braking/driving force Fvn takes a negative value, at Step 130.

When the target braking/driving force Fvn and the target yaw moment Mvn are not 0 under the condition where the target braking/driving force Fvn and the target yaw moment Mvn cannot be achieved by the control of the braking/driving force of each wheel, the point of intersection Q of the segment L, which links the point P that shows the vehicle target braking/driving force Fvn and the vehicle target yaw moment Mvn and the origin O, and the outer line of the quadrangular 100 is obtained as the target point, and the vehicle target braking/driving force Fvt after the modification and the vehicle target yaw moment Mvt after the modification are set respectively to Fvq and Mvq that are the values at the point Q at Step 140.

Consequently, according to the illustrated first embodiment, when the vehicle is under the condition where the target braking/driving force Fvn and the target yaw moment Mvn cannot be achieved by the control of the braking/driving force of each wheel, the vehicle target braking/driving force Fvt after the modification and the vehicle target yaw moment Mvt after the modification are calculated such that, within the range where the ratio of the vehicle target braking/driving force Fvt and the yaw moment Mvt after the modification through the control of the braking/driving force of each wheel coincides with the ratio of the target braking/driving force Fvn and the target yaw moment Mvn through the control of the braking/driving force of each wheel required to the vehicle, the vehicle braking/driving force Fv and the yaw moment Mv by the target braking/driving forces Fwxti of the wheels take the greatest values. Therefore, the braking/driving force of each wheel is controlled such that the ratio of the vehicle braking/driving force and the yaw moment surely coincides with the ratio of the target braking/driving forces and the target yaw moment, with the result that the braking/driving force and the yaw moment required to the vehicle can be achieved as much as possible within the range of the braking/driving force that can be generated by the wheels.

In particular, in the illustrated first embodiment, the driving sources for the wheels are electric motor generators 12FL to 12RR provided on each wheel. In case where the target braking/driving forces Fwxti of the wheels take negative values, which means the target braking/driving forces Fwxti are braking forces, the regenerative braking forces by the electric motor generators 12FL to 12RR are used. Accordingly, the vehicle motion energy can effectively be returned as electric energy upon the braking operation for deceleration, while achieving the braking/driving force and the yaw moment required to the vehicle as much as possible within the range of the braking/driving forces that can be generated by the wheels.

While, in the illustrated first embodiment, the electric motor generators 12FL to 12RR are in-wheel motors, the electric motor generators may be provided at the vehicle body. Further, the electric motor generators as driving sources for wheels may not perform regenerative braking. The driving source may be other than the electric motor generator so long as it can increase or decrease the driving force of each wheel independently.

Although the electric motor generators 12FL to 12RR are provided so as to correspond to four wheels in the illustrated first embodiment, this embodiment may be applied to a vehicle having driving sources provided only at the left and right front wheels or left and right rear wheels. In this case, the quadrangle 100 takes a form shown by 100′ in FIG. 4C, and when the vehicle yaw moment in the leftward turning and the vehicle yaw moment in the rightward direction are the maximum values Mvlmax and Mvrmax respectively, the vehicle braking/driving force takes a negative value, which means that the vehicle braking/driving force is a braking force. The above-mentioned effects can also be achieved with this vehicle.

### Second Embodiment

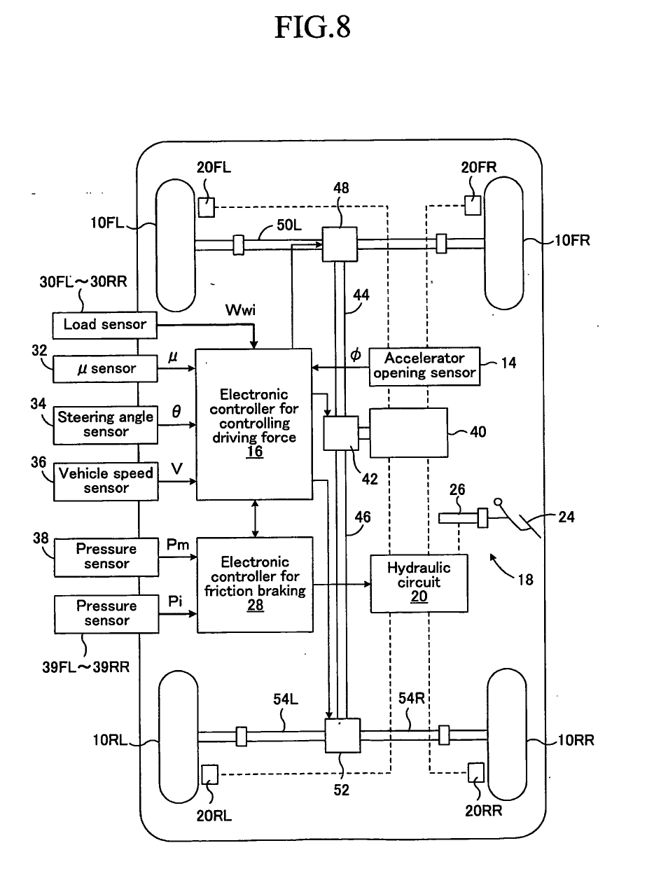

FIG. 8 is a schematic block diagram showing a braking/driving force control apparatus applied to a right-hand four-wheel drive vehicle in which driving force and regenerative braking force from a single electric motor generator, which is common to four wheels, are controlled so as to be distributed to front and rear wheels and right and left wheels according to a second embodiment of the present invention. The components in FIG. 8 same as those in FIG. 1 are identified by the same numerals in FIG. 1.

In this second embodiment, an electric motor generator 40 is provided that serves as a driving source common to the front left wheel 10FL, front right wheel 10FR, rear left wheel 10RL, and rear right wheel 10RR. The driving force and the regenerative braking force from the electric motor generator 40 is transmitted to a front-wheel propeller shaft 44 and rear-wheel propeller shaft 46 through a center differential 42 that can control the distribution ratio to the front wheels and rear wheels.

The driving force or the regenerative braking force of the front-wheel propeller shaft 44 is transmitted to the front-left wheel shaft 50L and front-right wheel shaft 50R by a front-wheel differential 48 that can control the distribution ratio to the front-left wheel and front-right wheel, whereby the front-left wheel 10FL and front-right wheel 10FR are rotatably driven. Similarly, the driving force or the regenerative braking force of the rear-wheel propeller shaft 46 is transmitted to the rear-left wheel shaft 54L and rear-right wheel shaft 54R by a rear-wheel differential 52 that can control the distribution ratio of the rear-left wheel and rear-right wheel, whereby the rear-left wheel 10RL and rear-right wheel 10RR are rotatably driven.

The driving force of the electric motor generator 40 is controlled by the electronic controller 16 for controlling driving force on the basis of the accelerator opening φ detected by the accelerator opening sensor 14. The regenerative braking force of the electric motor generator 40 is also controlled by the electronic controller 16 for controlling driving force. The electronic controller 16 for controlling driving force controls the distribution ratio of the driving force and regenerative braking force to the front wheels and rear wheels by the center differential 42, controls the distribution ratio of the driving force and regenerative braking force to the left wheels and right wheels by the front-wheel differential 48, and controls the distribution ratio of the driving force and regenerative braking force to the left wheels and right wheels by the rear-wheel differential 52.

In this second embodiment too, the electronic controller 16 for controlling driving force calculates, in the same manner as in the first embodiment, the target braking/driving force Fvn, required to the vehicle, through the control of the braking/driving force of each wheel, the vehicle target yaw moment Mvn, required to the vehicle, through the control of the braking/driving force of each wheel, the vehicle maximum driving force Fvdmax, the vehicle maximum braking force Fvbmax, the vehicle maximum yaw moment Mvlmax in the leftward turning direction, and the vehicle maximum yaw moment Mvrmax in the rightward turning direction by the braking/driving force of each wheel.

In the illustrated second embodiment, it is assumed that the driving forces Fwdi of the wheels when the maximum driving force of the electric motor generator 40 is uniformly distributed to the front-left wheel 10FL, front-right wheel 10FR, and rear-left wheel 10RL and rear-right wheel 10RR is smaller than the producible maximum longitudinal force that is determined by the friction coefficient μ of the normal road surface.

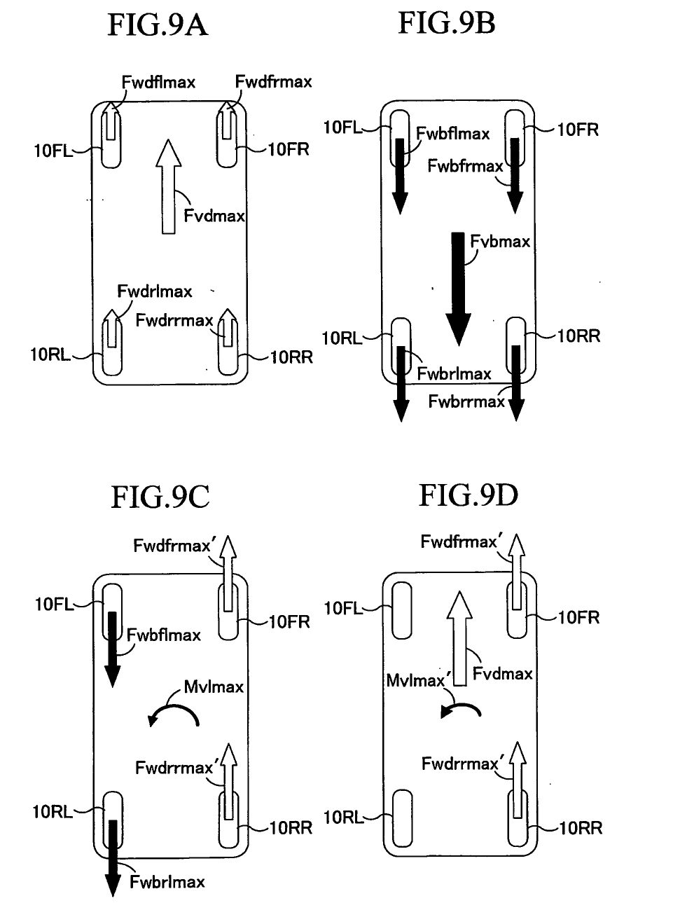

As shown in FIG. 9A, the vehicle maximum driving force Fvdmax under the condition where the yaw moment by the braking/driving forces of the wheels is not acted on the vehicle is achieved when the braking/driving forces Fwxfl and Fwxfr of the front-left wheel 10FL and front-right wheel 10FR are the maximum driving forces Fwdflmax and Fwdfrmax in case where the distribution of the driving force to the right and left wheels is equal, and the braking/driving forces Fwxrl and Fwxrr of the rear-left wheel 10RL and rear-right wheel 10RR are the maximum driving forces Fwdrlmax and Fwdrrmax in case where the distribution of the driving force to the left wheels and right wheels is equal.

As shown in FIG. 9B, the vehicle maximum braking force Fvbmax under the condition where the yaw moment by the braking/driving force to the wheels is not acted on the vehicle is achieved when the braking/driving forces Fwxfl and Fwxfr of the front-left wheel 10FL and front-right wheel 10FR are the maximum braking forces Fwbflmax and Fwbfrmax in case where the distribution of the braking force to the left wheels and right wheels is equal, and the braking/driving forces Fwxrl and Fwxrr of the rear-left wheel 10RL and rear-right wheel 10RR are the maximum braking forces Fwbrlmax and Fwbrrmax in case where the distribution of the braking force to the right and left wheels is equal.

As shown in FIG. 9C, the vehicle maximum yaw moment Mvlmax in the leftward turning direction under the condition where the longitudinal force by the braking/driving forces of the wheels is not acted on the vehicle is achieved in case where the driving force is distributed to the right wheels, the braking/driving forces Fwxfr and Fwxrr of the front-right wheel 10FR and rear-right wheel 10RR are the maximum driving forces Fwdfrmax′ and Fwdrrmax′, and their magnitudes are equal to the magnitudes of the maximum braking forces Fwbflmax and Fwbrlmax of the front-left wheel 10FL and rear-left wheel 10RL respectively.

As shown in FIG. 9D, the vehicle maximum yaw moment Mvlmax′ in the leftward turning direction under the condition where the vehicle braking/driving force is the maximum driving force Fvdmax is achieved in case where the braking/driving forces Fwxfl and Fwxrl of the front-left wheel 10FL and rear-left wheel 10RL are respectively 0, and the braking/driving forces Fwxfr and Fwxrr of the front-right wheel 10FR and rear-right wheel 10RR are the maximum driving forces Fwdflmax′ and Fwdrrmax′.

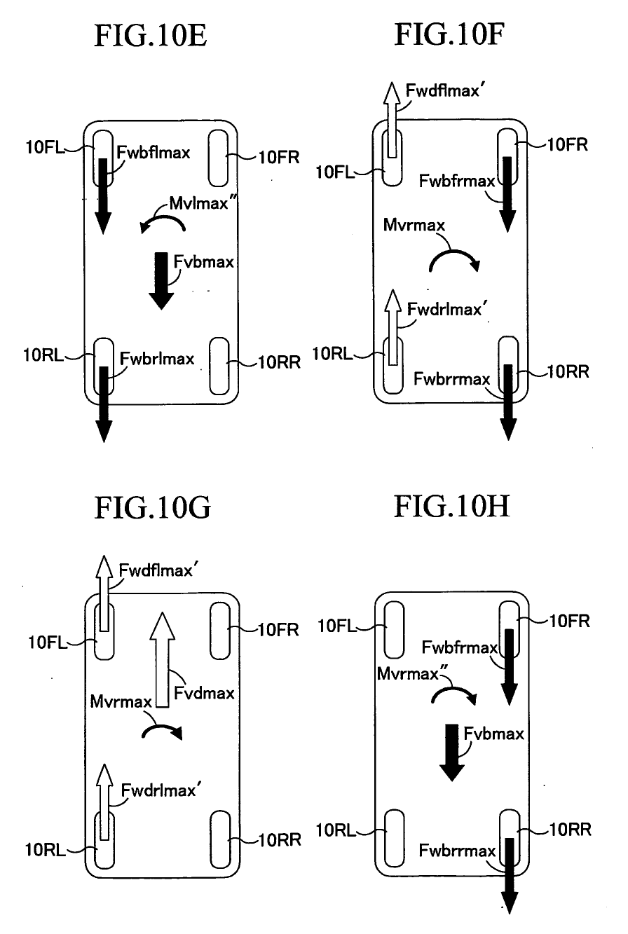

As shown in FIG. 10E, the vehicle maximum yaw moment Mvlmax″ in the leftward turning direction under the condition where the driving force is not acted on any wheels is achieved in case where the braking/driving forces Fwxfr and Fwxrr of the front-right wheel 10FR and rear-right wheel 10RR are respectively 0, and the braking/driving forces Fwxfl and Fwxrl of the front-left wheel 10FL and rear-left wheel 10RL are the maximum braking forces Fwbflmax and Fwbrlmax.

As shown in FIG. 10F, the vehicle maximum yaw moment Mvrmax in the rightward turning direction under the condition where the longitudinal force by the braking/driving forces of the wheels is not acted on the vehicle is achieved in case where the driving force is distributed to the left wheels, the braking/driving forces Fwxfl and Fwxrl of the front-left wheel 10FL and rear-left wheel 10RL are the maximum driving forces Fwdflmax′ and Fwdrlmax′, and their magnitudes are equal to the magnitudes of the maximum braking forces Fwbfrmax and Fwbrrmax of the front-right wheel 10FR and rear-right wheel 10RR respectively.

As shown in FIG. 10G, the vehicle maximum yaw moment Mvrmax′ in the rightward turning direction under the condition where the vehicle braking/driving force is the maximum driving force Fvdmax is achieved in case where the braking/driving forces Fwxfr and Fwxrr of the front-right wheel 10FR and rear-right wheel 10RR are respectively 0, and the braking/driving forces Fwxfl and Fwxrl of the front-left wheel 10FL and rear-left wheel 10RL are the maximum driving forces Fwdflmax′ and Fwdrlmax′.

As shown in FIG. 10H, the vehicle maximum yaw moment Mvrmax″ in the rightward turning direction under the condition where the driving force is not acted on any wheels is achieved in case where the braking/driving forces Fwxfl and Fwxrl of the front-left wheel 10FL and rear-left wheel 10RL are respectively 0, and the braking/driving forces Fwxfr and Fwxrr of the front-right wheel 10FR and rear-right wheel 10RR are the maximum braking forces Fwbfrmax and Fwbrrmax.

The maximum driving forces Fwdimax of the wheels are determined by the maximum output torque of the electric motor generator 40, the road friction coefficient μ, and each distribution ratio, and the maximum braking forces Fwbimax of the wheels are determined by the road friction coefficient μ. Therefore, the vehicle maximum driving force Fvdmax, vehicle maximum braking force Fvbmax, vehicle maximum yaw moment Mvlmax in the leftward turning direction, and vehicle maximum yaw moment Mvrmax in the rightward turning direction are also determined by the maximum output torque of the electric motor generator 40 and the road friction coefficient μ. Accordingly, if the maximum output torque of the electric motor generator 40 and the road friction coefficient μ are found, the vehicle maximum driving forces Fvdmax and the other values can be estimated.

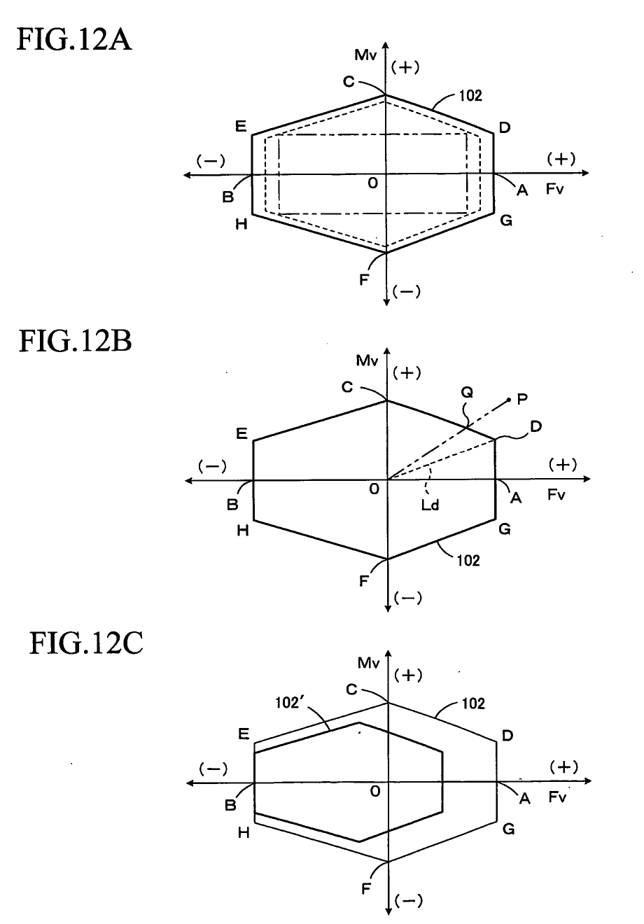

As shown in FIG. 12A, in a rectangular coordinate with the vehicle driving/braking force Fvx as abscissa and the vehicle yaw moment Mv as ordinate, the vehicle braking/driving force Fvx and the vehicle yaw moment Mv that can be achieved by the control of the braking/driving force of each wheel take values within a hexagon 102 decided by the vehicle maximum driving force Fvdmax, vehicle maximum braking force Fvbmax, vehicle maximum yaw moment Mvlmax in the leftward turning direction, vehicle maximum yaw moment Mvrmax in the rightward turning direction, and the variable range of the vehicle yaw moment Mv when vehicle braking/driving force Fvx are the maximum driving force Fvdmax or maximum braking force Fvbmax.

Notably, in FIG. 12, points A to H correspond to the cases A to H in FIGS. 9 and 10. As shown by a broken line in FIG. 12A, the hexagon 102 becomes small as the road friction coefficient μ decreases. Further, as the magnitude of the steering angle θ increases, the lateral force of front left and front right wheels, that are steerable wheels, increases, so that the allowance of the longitudinal force becomes small. Therefore, the hexagon 102 becomes small as magnitude of the steering angle θ increases.

When the output torque of the electric motor generator 40 is sufficiently great, the maximum driving force and maximum braking force of each wheel are determined by the road friction coefficient μ. Therefore, supposing that the vehicle accelerating direction and the vehicle leftward turning direction are defined as positive, the relationships between the maximum driving force and maximum braking force of each wheel, the vehicle maximum driving force and vehicle maximum braking force, and vehicle maximum yaw moment in the leftward turning direction and vehicle maximum yaw moment in the rightward turning direction are equal to those in the above-mentioned first embodiment. Accordingly, the range of the vehicle driving force and yaw moment that can be achieved by the braking/driving forces of the wheels becomes the range of the diamond like the first embodiment.

Further, when the output torque of the electric motor generator 40 and the maximum braking force of each wheel are smaller than those in the embodiment, the vehicle driving force becomes the maximum even if all the maximum driving force is distributed to the left wheels or right wheels, and the vehicle braking force becomes the maximum even if all the braking forces is distributed to the left wheels or right wheels. Therefore, as indicated by a phantom line in FIG. 12A, the range of the vehicle driving force and yaw moment that can be achieved by the braking/driving forces of the wheels becomes the range of the rectangle.

The coordinates at the points A to H shown in FIG. 12 are (Fvdmax, 0), (Fvbmax, 0), (0, Mvlmax), (Fvdmax, KmMvlmax), (Fvbmax, KmMvlmax), (0, Mvrmax), (Fvmax, −KmMvlmax), and (Fvbmax, −KmMvlmax), respectively, supposing that the coefficient Km is defined as not less than 0 and not more than 1.

Supposing that the longitudinal distribution ratio of the braking/driving force Fwxi to the rear wheels is defined as Kr (constant of 0<Kr<1), the lateral distribution ratio of the braking/driving force Fwxi to the right wheels is defined as Ky (0≦Kr≦1) for the front wheels and rear wheels, and the vehicle tread is defined as Tr, the following equations 5 to 8 are established. Accordingly, the electronic controller 16 for controlling driving force sets the vehicle target braking/driving force Fvt and the vehicle target yaw moment Mvt after the modification by the control of the braking/driving force of each wheel to the target braking/driving force Fvn and the vehicle target yaw moment Mvn, when the vehicle target braking/driving force Fvt and the vehicle target yaw moment Mvt are within the above-mentioned hexagon 102. For example, it calculates the values satisfying the following equations 5 to 8 as the target braking/driving force Fwxti (i=fl, fr, rl, rr) and the lateral distribution ratio Ky to the right wheels by the least square method.

Fwxfl+Fwxfr+Fwxrl+Fwxrr=Fvt (5)

{Fwxfr+Fwxrr−(Fwxfl+Fwxrl)}Tr/2=Mvt (6)

(Fwxfl+Fwxfr)Kr=(Fwxrl+Fwxrr)(1−Kr) (7)

(Fwxfl+Fwxrl)Ky=(Fwxfr+Fwxrr)(1−Ky) (8)

When the vehicle target braking/driving force Fvn and the vehicle target yaw moment Mvn are outside the range of the above-mentioned hexagon 102, the electronic controller 16 for controlling driving force calculates the vehicle target braking/driving force Fvt and the vehicle target yaw moment Mvt after the modification such that the magnitude of the vehicle braking/driving force Fv and the magnitude of the yaw moment Mv by the target braking/driving forces Fwxti of the wheels become respectively the maximum within the range where the ratio of the vehicle target braking/driving force Fvt and the yaw moment Mvt after the modification by the braking/driving forces of the wheels becomes the ratio of the target braking/driving force Fvn and the target yaw moment Mvn, required to the vehicle, by the braking/driving forces of the wheels. Then, the electronic controller 16 for controlling driving force calculates the values satisfying the foregoing equations 5 to 8 as the target braking/driving forces Fwxti of the wheels and the lateral distribution ratio Ky to the right wheels by the least square method, for example.

When the vehicle braking/driving force Fv takes a positive value which means the vehicle braking/driving force Fv is a driving force, and the target braking/driving forces Fwxti of the wheels are positive values that means the braking/driving forces Fwxti are driving forces, the electronic controller 16 for controlling driving force sets the target friction braking forces Fwbti and the target regenerative braking forces Fwrti (i=fl, fr, rl, rr) of the wheels to zero, outputs the signals indicating the target friction braking forces Fwbti to the electronic controller 28 for controlling braking force, and sets the target driving forces Fwdti (i=fl, fr, rl, rr) of the wheels to the target braking/driving forces Fwxti.

Then, the electronic controller 16 for controlling driving force calculates the target driving current It to the electric motor generator 40 and the lateral distribution ratio Ky to the right wheels by unillustrated maps or functions on the basis of the target driving forces Fwdti, and controls the driving current applied to the electric motor generator 40 on the basis of the target driving current It as well as controls the front-wheel differential 48 and the rear-wheel differential 52 on the basis of the lateral distribution ratio Ky to the right wheels, thereby controlling the driving force of each wheel such that the driving/braking forces Fwxi of the wheels become the target braking/driving forces Fwxti.

On the other hand, when the vehicle braking/driving force Fv takes a positive value that means the vehicle braking/driving force Fv is a driving force, but the target braking/driving force Fwxti of any one of wheels takes a negative value that means it is a braking force, and when the vehicle braking/driving force Fv takes a negative value that means it is a braking force, but the target braking/driving force Fwxti of any one of wheels takes a positive value that means it is a driving force, the electronic controller 16 for controlling driving force determines the lateral distribution ratio Ky to the right wheels such that the driving force is distributed only to the side where the target braking/driving forces Fwxti take positive values, calculates the target driving current It to the electric motor generator 40 on the basis of the sum of the positive target braking/driving forces Fwxti, and outputs signals indicating the target braking/driving forces Fwxti to the electronic controller 28 for controlling braking force such that the friction braking force by the friction braking apparatus 18 is applied to the wheel having the negative target braking/driving force Fwxti.

Then, the electronic controller 16 for controlling driving force controls the driving current applied to the electric motor generator 40 on the basis of the target driving current It, and controls the front-wheel differential 48 and the rear-wheel differential 52 on the basis of the lateral distribution ratio Ky to the right wheels. The electronic controller 28 for controlling braking force applies the friction braking force according to the target braking/driving force Fwxti to the wheel having the negative target braking/driving force Fwxti. Accordingly, the braking/driving forces Fwxi of the wheels are controlled to coincide with the target braking/driving forces Fwxti.

When the sum of the target braking/driving forces Fwxti is not more than the maximum regenerative braking force by the electric motor generator 40 in case where the vehicle braking/driving force Fv takes a negative value that means it is a braking force, and the target braking/driving forces Fwxti of the wheels take negative values that means the are braking forces, the electronic controller 16 for controlling driving force sets the target driving forces Fwdti and the target friction braking forces Fwbti of the wheels to 0, and sets the target regenerative braking force Frt to the sum of the target braking/driving forces Fwxti, thereby controlling the lateral distribution ratio Ky to the right wheels and the electric motor generator 40 such that the regenerative braking force becomes the target regenerative braking force Frt.

When the magnitude of the target braking/driving force Fwxti of any one of wheels is greater than the maximum regenerative braking force by the electric motor generator 40 in case where the vehicle braking/driving force Fv takes a negative value that means it is a braking force, and the target braking/driving forces Fwxti of the wheels take negative values that means they are braking forces, the electronic controller 16 for controlling driving force sets the target driving forces Fwdti of the wheels to 0, sets the regenerative braking force by the electric motor generator 40 to the maximum regenerative braking force, and sets the lateral distribution ratio Ky to the right wheels such that the distribution ratio of the regenerative braking force to the wheel having the greater target braking/driving force Fwxti increases.

Then, the electronic controller 16 for controlling driving force calculates, as the target friction braking forces Fwbti, the values obtained by the subtraction from the target braking/driving forces Fwxti of the wheels the associated regenerative braking forces of the wheels, and outputs the signals indicating the target friction braking forces Fwbti to the electronic controller 28 for controlling braking force. Further, the electronic controller 16 for controlling driving force controls the electric motor generator 40 such that the regenerative braking force becomes the maximum regenerative braking force, and controls the front-wheel differential 48 and the rear-wheel differential 52 on the basis of the lateral distribution ratio Ky to the right wheels.

In this second embodiment too, the electronic controller 28 for controlling braking force calculates the target braking pressures Pbti (i=fl, fr, rl, rr) of the wheels on the basis of the target friction braking forces Fwbti of the wheels inputted from the electronic controller 16 for controlling driving force, and controls the hydraulic circuit 20 such that the braking pressures Pbi of the wheels becomes the associated target braking pressures Pbti, thereby controlling such that the friction braking force Fwbi (i=fl, fr, rl, rr) to each wheel becomes the target friction braking forces Fwbti of the wheels.

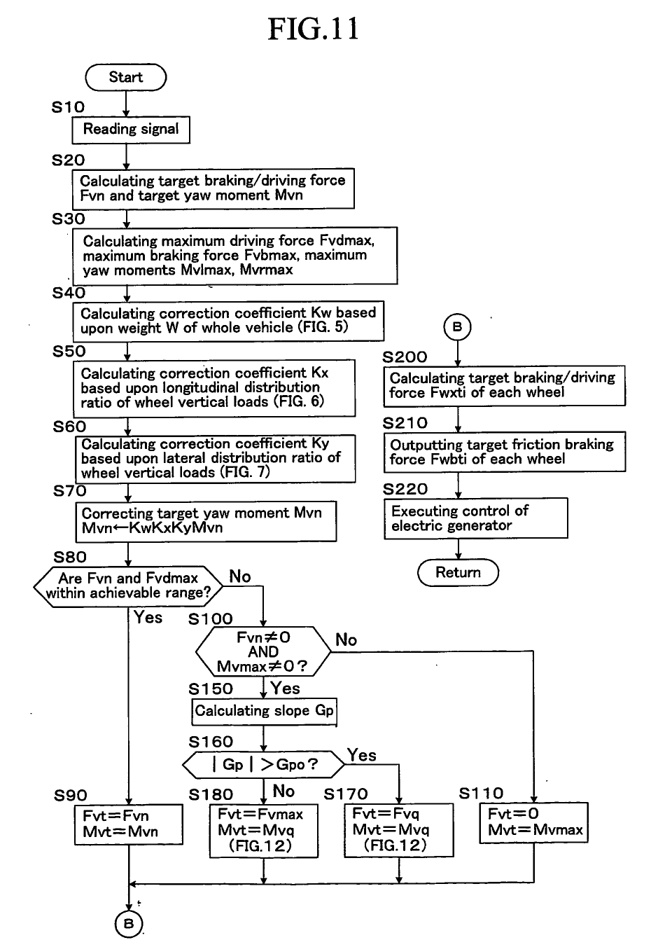

The braking/driving force control in the second embodiment will now be explained with reference to the flowchart shown in FIG. 11. Steps in FIG. 11 same as Steps shown in FIG. 3 are identified by the same numbers. The control by the flowchart shown in FIG. 11 is started by the activation of the electronic controller 16 for controlling driving force, and it is repeatedly executed every predetermined time until an ignition switch, not shown, is turned off.

In this second embodiment, Steps 10 to 110 and Steps 200 to 220 are executed in the same manner as in the first embodiment. When the positive determination is made at Step 100, the slope Gp of the segment L linking the point P, which represents the target braking/driving force Fvn and the target yaw moment Mvn, and the origin in FIG. 12, is calculated at Step 150.

It is determined at Step 160 whether or not the absolute value of the slope Gp is greater than a reference slope Gpo, which is defined by the slope of the segment Ld linking the point D and the origin in FIG. 12. When the negative determination is made, the program proceeds to Step 180. When the positive determination is made, the program proceeds to Step 170.

At Step 170, the point of intersection Q of the segment L, that links the point P representing the vehicle target braking/driving force Fvt and the vehicle target yaw moment Mvt and the origin O, and the outer line of the hexagon 102, is obtained as the target point, as shown in FIG. 12B, and if the coordinate of the target point Q is defined as (Fvq, Mvq), the vehicle target braking/driving force Fvt after the correction and the vehicle target yaw moment Mvt after the correction are set respectively to Fvq and Mvq. Thereafter, the program proceeds to Step 200. In this case, when the target braking/driving force Fvn takes a positive value, the vehicle target braking/driving force Fvt after the correction is a driving force. When the target braking/driving force Fvn takes a negative value, the vehicle target braking/driving force Fvt after the correction is a braking force. When the target yaw moment Mvn takes a positive value, the vehicle target yaw moment Mvt after the correction is set to the yaw moment in the leftward turning direction. When the target yaw moment Mvn takes a negative value, the vehicle target yaw moment Mvt after the correction is set to the yaw moment in the rightward turning direction.

At Step 180, the vehicle target braking/driving force Fvt after the correction is set to the braking/driving force Fvq at the coordinate of the point of intersection Q of the segment L and the outer line of the hexagon 102, and the vehicle target yaw moment Mvt after the correction is set to the yaw moment Mvq at the coordinate of the point of intersection Q. Thereafter, the program proceeds to Step 200. In this case, when the target braking/driving force Fvn takes a positive value, the vehicle target braking/driving force Fvt after the correction is the maximum driving force Fvdmax. When the target braking/driving force Fvn takes a negative value, the vehicle target braking/driving force Fvt after the correction is the maximum braking force Fvbmax. When the target yaw moment Mvn takes a positive value, the vehicle target yaw moment Mvt after the correction is set to the yaw moment in the leftward turning direction. When the target yaw moment Mvn takes a negative value, the vehicle target yaw moment Mvt after the correction is set to the yaw moment in the rightward turning direction.

The control same as that in the above-mentioned first embodiment is executed at Step 210 in this second embodiment, except that the target regenerative braking force Frt and the target friction braking forces Fwbti of the wheels are calculated as described above.

Thus, in the second embodiment, Steps 10 to 70 are executed by the same manner as in the first embodiment. Therefore, the optimum yaw moment can be applied to the vehicle according to the weight W of the whole vehicle, the longitudinal distribution ratio Rx of the wheel vertical loads, the lateral distribution ratio Ry of the wheel vertical loads, and the vehicle turning direction, whereby the vehicle is stably driven regardless of the variation in the weight W of the whole vehicle, the longitudinal distribution ratio Rx of the wheel vertical loads, and the lateral distribution ratio Ry of the wheel vertical loads, and the vehicle turning direction.

According to the second embodiment, in particular, when the target braking/driving force Fvn and the target yaw moment Mvn are not 0 under the condition where the target braking/driving force Fvn and the target yaw moment Mvn cannot be achieved by the control of the braking/driving force of each wheel, the slope Gp of the segment L linking the point P that shows the vehicle target braking/driving force Fvn and the vehicle target yaw moment Mvn and the origin O in FIG. 12 is calculated at Step 110, and at Steps 120 to 140, the point of intersection Q of the segment L, and the outer line of the hexagon 102 is obtained as the target point, and the vehicle target braking/driving force Fvt after the correction and the vehicle target yaw moment Mvt after the correction are set respectively to Fvq and Mvq that are the values at the target point, in accordance with the degree of the slope of the segment L with respect to the reference slope Gpo.

Consequently, according to the illustrated second embodiment, when the vehicle; in which left and right wheels are braked and driven by an electric motor generator common to these wheels, and driving force and regenerative braking force are controlled so as to be distributed to left and right wheels, is under the condition where the target braking/driving force Fvn and the target yaw moment Mvn cannot be achieved by the control of the braking/driving force of each wheel, the vehicle target braking/driving force Fvt after the modification and the vehicle target yaw moment Mvt after the modification are calculated such that, within the range where the ratio of the vehicle target braking/driving force Fvt and the yaw moment Mvt after the modification through the control of the braking/driving force of each wheel coincides with the ratio of the target braking/driving force Fvn and the target yaw moment Mvn through the control of the braking/driving force of each wheel required to the vehicle, the vehicle braking/driving force Fv and the yaw moment Mv take the greatest values in magnitude attainable by the target braking/driving force Fwxti of each wheel. Therefore, like the above-mentioned first embodiment, the braking/driving force of each wheel is controlled such that the ratio of the vehicle braking/driving force and the yaw moment surely coincides with the ratio of the target braking/driving force and the target yaw moment, with the result that the braking/driving force and the yaw moment required to the vehicle can be achieved as much as possible within the range of the braking/driving force that can be generated by each wheel.

According to the illustrated second embodiment, the electric motor generator 40 that is common to all the wheels and serves as a driving source generates a regenerative braking force, in case where the vehicle target braking/driving force Fvt takes a negative value that means it is a braking force. Therefore, like the above-mentioned first embodiment, the vehicle motion energy can effectively be returned as electric energy upon the braking operation for deceleration, while achieving the braking/driving force and the yaw moment required to the vehicle as much as possible within the range of the braking/driving force that can be generated by each wheel.

According to the illustrated first and second embodiments, the vehicle target longitudinal acceleration Gxt is calculated on the basis of the accelerator opening φ and the master cylinder pressure Pm that indicate the amount of acceleration or deceleration operation by a driver, the vehicle target yaw rate γt is calculated on the basis of the steering angle θ, which is a steering operation amount by a driver, and the vehicle speed V, the target barking/driving force Fvn required to the vehicle is calculated on the basis of the vehicle target longitudinal acceleration Gxt, and the target total yaw moment Mvnt required to the vehicle is calculated on the basis of the vehicle target yaw moment γt.

The vehicle turning yaw moment Ms by the lateral force of each wheel is calculated, and the value obtained by subtracting the turning yaw moment Ms from the vehicle target total yaw moment Mvnt is calculated as the vehicle target yaw moment Mvn, which is required to the vehicle and is to be attained by the control of the braking/driving force of each wheel. Therefore, the vehicle target yaw moment required to the vehicle to be attained by the control of the braking/driving force of each wheel can be surely and correctly calculated in just proportion, compared to the case where the vehicle turning yaw moment Ms attained by the lateral forces of the wheels is not considered.

Although the driving source is the electric motor generator 40 that is common to four wheels in the illustrated second embodiment, the driving source for driving the wheels so as to execute the control of the driving force distribution between left and right wheels may be optional driving means known by a person skilled in the art, such as an internal combustion engine, hybrid system, or the like.

Although a single electric motor generator 40 is provided as a common driving source to four wheels in the illustrated second embodiment, a driving source common to the front-left wheel and front-right wheel and a driving source common to the rear-left wheel and rear-right wheel may be provided. Further, a driving source common to only the front-left wheel and front-right wheel or a driving source common to only the rear-left wheel and rear-right wheel may be provided. In this case, the hexagon 102 takes a shape 102′ shown in FIG. 12C. Specifically, when the vehicle yaw moment in the leftward turning direction and the vehicle yaw moment in the rightward turning direction are the maximum values Mvlmax and Mvrmax respectively, the vehicle braking/driving force takes a negative value, which means that the vehicle braking/driving force is a braking force. The above-mentioned effects can also be achieved by this vehicle.

The present invention is explained in detail with respect to the specific embodiments, but the invention is not limited to the above-mentioned embodiments. It would be apparent for a person skilled in the art that various other modifications are possible within the scope of the present invention.

For example, in the above-mentioned first and second embodiments, the weight W of the whole vehicle, the longitudinal distribution ratio Rx of the wheel vertical loads, the lateral distribution ratio Ry of the wheel vertical loads, and vehicle turning direction are obtained, and the vehicle target yaw moment Mvn is corrected in accordance with the weight W of the whole vehicle, the longitudinal distribution ratio Rx of the wheel vertical loads, the lateral distribution ratio Ry of the wheel vertical loads, and vehicle turning direction. However, any one of the weight W of the whole vehicle, the longitudinal distribution ratio Rx of the wheel vertical loads, the lateral distribution ratio Ry of the wheel vertical loads, and vehicle turning direction may be omitted as the information for correcting the vehicle target yaw moment Mvn.

In the above-mentioned first and second embodiments, when it is determined that the target braking/driving force Fvn and the target yaw moment Mvn cannot be achieved by the control of the braking/driving force of each wheel, Steps 100 to 140 are executed, like the case of the Japanese Patent Application No. 2005-26758 filed by the applicant of the present application, whereby the vehicle target braking/driving force Fvt and the vehicle target yaw moment Mvt are calculated such that, within the range where the ratio of the vehicle braking/driving force and the yaw moment attained by the braking/driving forces of the wheels substantially becomes the ratio of the target braking/driving force and the target yaw moment, the vehicle braking/driving force and the yaw moment by the braking/driving force of each wheel take the greatest values in magnitude. However, the target braking/driving force Fvn and the target yaw moment Mvn may be corrected, in any optional manner, to the value within the range that can be achieved by the control of the braking/driving force of each wheel such that the magnitude of the vehicle braking/driving force or the vehicle yaw moment becomes great as much as possible within the range of the braking/driving force and the yaw moment that can be achieved by the braking/driving force of each wheel. For example, they may be corrected in the manner disclosed in the specifications and drawings of the Japanese Patent Application No. 2005-56758, Japanese Patent Application No. 2005-56770, Japanese Patent Application No. 2005-56490, Japanese Patent Application No. 2005-56492, Japanese. Patent Application No. 2005-56499, and Japanese Patent Application No. 2005-56503.

Although the vehicle is a right-hand drive vehicle in the above-mentioned first and second embodiments, the present invention may be applied to a left-hand drive vehicle. In this case, the correction coefficient Ky based upon the lateral distribution ratio Ry of the wheel vertical loads and the vehicle turning direction may be calculated by a map corresponding to the graph in which the turning direction is reversed from right to left with respect to FIG. 7.

Although the regenerative braking force is generated according to need by the electric motor generators 12FL to 12RR and the electric motor generator 40 in the aforesaid first and second embodiments, it may be revised such that the regenerative braking is not performed, even if the driving source is an electric motor generator, and the braking force is generated only by the friction braking.

The longitudinal distribution ratio Kr of the braking/driving force to the rear wheels is constant in the aforesaid first and second embodiments. However, the longitudinal distribution ratio Kr to the rear wheels may be variably set in accordance with the magnitude of the steering angle such that the longitudinal distribution ratio Kr to the rear wheels gradually increase as the magnitude of the steering angle increases, since in general, the lateral force of the steerable wheel increases and the allowable longitudinal force of the steerable wheel decreases as the magnitude of the steering angle increases.

In general, as the braking forces of the rear wheels increases upon the braking of the vehicle for deceleration, the lateral force of the rear wheels decreases to thereby deteriorate the running stability of the vehicle. Therefore, the longitudinal distribution ratio Kr to the rear wheels may be variably set in accordance with the vehicle target braking/driving force such that it decreases as the vehicle target braking/driving force takes a negative value and its magnitude is greater.

In the aforesaid first and second embodiments, the target braking/driving force Fvn and the target yaw moment Mvn by the control of the braking/driving force of each wheel required to the vehicle are calculated on the basis of the acceleration/deceleration operation amount and the steering operation amount by the driver. However, in case where the vehicle behavior is unstable, the target braking/driving force Fvn and the target yaw moment Mvn may be corrected so as to be calculated by considering the target longitudinal acceleration or target yaw rate, which are required to stabilize the behavior of the vehicle, in addition to the acceleration/deceleration operation amount and the steering operation amount by the driver.

In the aforesaid first embodiment, the vehicle is a four-wheel drive vehicle having electric motor generators serving as driving force applying means provided at each wheel, and in the aforesaid second embodiment, the vehicle is a four-wheel drive vehicle in which driving force and regenerative braking force from a single electric motor generator, which is common to four wheels, are controlled to be distributed to the front and rear wheels and left and right wheels. However, the vehicle to which the present invention is applicable is a vehicle that can apply different braking/driving force to at least each of a pair of left and right wheels, more preferably a vehicle that can apply different braking/driving force to at least each of a pair of left and right wheels, and the braking force of each wheel can independently be controlled. For example, the vehicle may be a four-wheel drive vehicle in which driving force is independently applied to each of the front-left wheel and front-right wheel, or driving force is controlled to be distributed, common driving force is applied to the rear-left wheel and rear-right wheel, and braking force of each wheel is independently controlled; a four-wheel drive vehicle in which driving force is independently applied to each of the rear-left wheel and rear-right wheel or driving force is controlled to be distributed, common driving force is applied to the front-left wheel and front-right wheel, and braking force of each wheel is independently controlled; a two-wheel drive vehicle in which driving force is independently applied to each of the front-left wheel and front-right wheel or driving force is controlled to be distributed, driving force is not applied to the rear-left wheel and rear-right wheel, and braking force of each wheel is independently controlled; or a two-wheel drive vehicle in which driving force is independently applied to each of the rear-left wheel and rear-right wheel or driving force is controlled to be distributed, driving force is not applied the front-left wheel and front-right wheel, and braking force of each wheel is independently controlled.

1. A vehicle braking/driving force control apparatus comprising:
braking/driving force applying means that can apply different braking/driving force to at least each of a pair of right and left wheels;
means for detecting an amount of driving operation by an occupant;
means for calculating a vehicle target braking/driving force and a vehicle target yaw moment, which should be generated by the braking/driving forces of the wheels, on the basis of at least the driving operation amount; and
control means for controlling the braking/driving forces applied to the wheels by said braking/driving force applying means so as to achieve said target braking/driving force and said target yaw moment, wherein
said apparatus further comprises means for obtaining the weight of the whole vehicle and correcting said target yaw moment in accordance with the weight of the whole vehicle.

2. A vehicle braking/driving force control apparatus comprising:
braking/driving force applying means that can apply different braking/driving force to at least each of a pair of right and left wheels;
means for detecting an amount of diving operation by an occupant;
means for calculating a vehicle target braking/driving force and a vehicle target yaw moment, which should be generated by the braking/driving forces of the wheels, on the basis of at least the driving operation amount; and
control means for controlling the braking/driving forces applied to the wheels by said braking/driving force applying means so as to achieve said target braking/driving force and said target yaw moment, wherein
said apparatus further comprises means for estimating the position of the center of gravity of the whole vehicle and correcting said target yaw moment in accordance with the position of the center of gravity of the whole vehicle.

3. A vehicle braking/driving force control apparatus comprising:
braking/driving force applying means that can apply different braking/driving force to at least each of a pair of right and left wheels;
means for detecting an amount of driving operation by an occupant;
means for calculating a vehicle target braking/driving force and a vehicle target yaw moment, which should be generated by the braking/driving forces of the wheels, on the basis of at least the driving operation amount; and
control means for controlling the braking/driving forces applied to the wheels by said braking/driving force applying means so as to achieve said target braking/driving force and said target yaw moment, wherein
said apparatus further comprises means for determining the turning direction of the vehicle, and correcting said target yaw moment in accordance with the turning direction of the vehicle.

4. A vehicle braking/driving force control apparatus according to any one of claims 1 to 3, comprising:
means for modifying said target braking/driving force and/or said target yaw moment after the correction such that the magnitude of the vehicle braking/driving force and/or the magnitude of the vehicle yaw moment may be maximized as much as possible within the range of the braking/driving force and the yaw moment that can be achieved by the braking/driving forces of the wheels, in case where said target braking/driving force and/or said target yaw moment after the correction cannot be achieved by the braking/driving forces of the wheels.

5. A vehicle braking/driving force control apparatus'according to claim 1 or claim 4, wherein said means for correcting the target yaw moment corrects said target yaw moment so as to increase the magnitude thereof when the weight of the whole vehicle is great, compared to the case where the weight of the whole vehicle is small.

6. A vehicle braking/driving force control apparatus according to claim 2 or claim 4, wherein said means for correcting the target yaw moment corrects said target yaw moment so as to increase the magnitude thereof when the degree of the deviation of the position of the center of gravity close to the rear wheels is great, compared to the case where the degree of the deviation of the position of the center of gravity close to the rear wheels is small.

7. A vehicle braking/driving force control apparatus according to claim 6, wherein said means for correcting the target yaw moment determines the degree of the deviation of the position of center of gravity close to the rear wheels on the basis of the ratio of the vertical loads of the front wheels and rear wheels.

8. A vehicle braking/driving force control apparatus according to claim 3 or claim 4, wherein said means for correcting the target yaw moment obtains the lateral deviation of the position of center of gravity of the whole vehicle from the center of the vehicle, and corrects said target yaw moment so as to increase the magnitude thereof when the vehicle turns in the direction opposite to the direction of the lateral deviation of the position of center of gravity of the whole vehicle, compared to the case where the vehicle turns in the direction same as the direction of the lateral deviation of the position of center of gravity.

9. A vehicle braking/driving force control apparatus according to claim 8, wherein said means for correcting the target yaw moment determines the lateral deviation of the position of center of gravity of the whole vehicle on the basis of the ratio of the vertical loads of the right wheels and the left wheels.
